(19) United States
(12) Patent Application Publication
(10) Pub. No.: US 2023/0166869 A1
(43) Pub. Date: Jun. 1, 2023

(54) AIRCRAFT PROPULSION ASSEMBLY COMPRISING AT LEAST ONE DEVICE FOR CLEANING A NACELLE AIR INTAKE BY SPRAYING A CLEANING LIQUID

(71) Applicant: Airbus Operations SAS, TOULOUSE (FR)

(72) Inventors: Gregory ALBET, TOULOUSE (FR); Jérôme BENQUET, TOULOUSE (FR)

(21) Appl. No.: 17/988,122

(22) Filed: Nov. 16, 2022

(30) Foreign Application Priority Data
Nov. 29, 2021 (FR) 2112626

(51) Int. Cl. B64F 5/30; B64C 7/02; B08B 3/02

(52) U.S. Cl. CPC B64F 5/30; B64C 7/02; B08B 3/02

(57) ABSTRACT

An aircraft propulsion assembly includes a power unit, a nacelle positioned around the power unit, and a cleaning device configured to remove insect residue and in order to maintain optimal aerodynamic characteristics. This cleaning device is configured to spread at least a cleaning liquid over an exterior and forward region of the air intake of the nacelle, the cleaning liquid being entrained by a high-speed airflow generated by the power unit and acting as a high-pressure water jet to encourage the removal of the insect residue.

### CROSS-REFERENCES TO RELATED APPLICATIONS

This application claims the benefit of the French patent application No. 2112626 filed on Nov. 29, 2021, the entire disclosures of which are incorporated herein by way of reference.

### FIELD OF THE INVENTION

The present application relates to an aircraft propulsion assembly comprising at least one device for cleaning a nacelle air intake by spraying a cleaning liquid.

### BACKGROUND OF THE INVENTION

According to one embodiment visible in FIG. 1, an aircraft 10 comprises several propulsion assemblies 12 positioned beneath the wings 14 of the aircraft 10 and connected to these wings by struts 16. Each propulsion assembly 12 comprises a power unit 18, such as a turbojet engine, positioned inside a nacelle 20.

For the purposes of the remainder of the description, a longitudinal direction is parallel to the engine axis A18 of the power unit 18 and a radial direction is perpendicular to the engine axis A18. A longitudinal plane contains the engine axis A18 of the power unit 18. A transverse plane is a plane perpendicular to the engine axis A18. The ideas of front/rear, denoted Av/Ar, refer to the direction in which an airflow 22 flows through the nacelle 20 from the front (Av) toward the rear (Ar).

The nacelle 20 has an approximately tubular shape and comprises, at the front, an air intake 24 via which the airflow 22 enters. In a configuration visible in FIG. 2, the air intake 24 comprises a lip 26, an interior duct 28 extending the lip 26 toward the inside of the nacelle 20 and an exterior wall 30 extending the lip 26 on the outside of the nacelle 20.

According to one embodiment, the air intake has a laminar aerodynamic profile (limiting aerodynamic disturbances) making it possible to achieve improvements in terms of aerodynamic performance.

In operation, when insects impact on the air intake 24, insect residue R remains attached to the surfaces of the lip 26 of the interior duct 28 and of the exterior wall 30 and disrupts the flows of air in contact with the surfaces, resulting in the loss of the improvements in terms of aerodynamic performance afforded by the laminar aerodynamic profile of the air intake, in an increase in the drag of the aircraft and in the fuel consumption thereof. Therefore, this dirt needs to be cleaned off regularly between two flights when the aircraft is on the ground. Now, this insect residue has a tendency to stick very firmly to the surface, making it difficult to remove.

The present invention seeks to overcome all or some of the disadvantages of the prior art.

### SUMMARY OF THE INVENTION

To this end, one subject of the invention is an aircraft propulsion assembly comprising a power unit having a fan and an engine axis oriented in a longitudinal direction as well as a nacelle positioned around the power unit, the nacelle comprising a lip, an interior duct extending the lip toward the inside of the nacelle and an exterior wall extending the lip on the outside of the nacelle, the lip, the interior duct and the exterior wall exhibiting an aerodynamic surface, the fan, during operation, generating an induction phenomenon and an incoming airflow in contact with an exterior and forward region of the aerodynamic surface.

According to the invention, the propulsion assembly comprises a cleaning device configured to spread at least a cleaning liquid over at least part of the exterior and forward region of the aerodynamic surface against which the incoming airflow flows. In addition, the cleaning device comprises several spray systems distributed over at least part of the circumference of the nacelle and configured to spray the cleaning liquid toward the exterior and forward region.

In operation, the cleaning liquid is entrained by the airflow entering at high speed and acts as a high-pressure waterjet encouraging removal of insect residue. In the case of an air intake with a laminar aerodynamic profile (that limits disturbances), the improvement achieved in terms of aerodynamic performance is maintained.

According to another feature, the nacelle comprises a front frame in the form of an annulus which extends between an interior edge and an exterior edge, the lip having an interior rear edge situated approximately in the continuation of the front frame in the vicinity of the interior edge of the front frame, and an exterior rear edge situated approximately in the continuation of the front frame in the vicinity of the exterior edge of the front frame. In addition, each spray system comprises at least one nozzle configured to generate a jet of cleaning liquid, each spray system being positioned in a manner that is offset toward a rear region with respect to the exterior rear edge of the lip and oriented in such a way as to spray the jet of cleaning liquid toward the front.

According to another feature, the jet of cleaning liquid forms an angle of less than 70° with respect to the longitudinal direction.

According to another feature, each spray system comprises several nozzles generating jets of cleaning liquid oriented in different directions.

According to another feature, each spray system comprises three nozzles, a first nozzle spraying a jet of cleaning liquid oriented toward the front and parallel to the longitudinal direction, a second nozzle spraying a jet of cleaning liquid oriented toward the front and forming an angle of between +30 and +60° with respect to the longitudinal direction, and a third nozzle spraying a jet of cleaning liquid oriented toward the front and forming an angle of between −30° and −60°.

According to another feature, each spray system is fixed, positioned on the aerodynamic surface and comprises a casing projecting from the aerodynamic surface.

According to another feature, each spray system is mobile being able to move between a retracted position in which the spray system does not project from the aerodynamic surface and a deployed position in which the spray system projects from the aerodynamic surface and can spray the cleaning liquid.

According to another feature, the spray system comprises a telescopic strut having a first part secured to the nacelle and a second part that is mobile relative to the first part and on which there is positioned at least one nozzle in such a way that the nozzle projects from the aerodynamic surface when the spray system is in the deployed position and does not project from the aerodynamic surface when the spray system is in the retracted position.

According to another feature, the second part has a free end distant from the first part and positioned at the aerodynamic surface when the spray system is in the retracted position, the free end having a shape that lies flush with the aerodynamic surface.

According to another feature, the cleaning device comprises at least one reservoir containing the cleaning liquid, a network of pipes connecting each spray system to the reservoir and at least one pump for conveying the cleaning liquid from the reservoir to the spray systems.

According to another feature, the cleaning liquid has rheological properties that allow it to form a persistent film on the aerodynamic surface.

Another subject of the invention is a method of operating a cleaning device of an aircraft propulsion assembly, characterized in that the cleaning device is activated for at least two seconds during which the power unit generates maximum thrust prior to takeoff.

According to another feature, the cleaning device is activated for an activation duration of between 5 and 15 seconds.

### BRIEF DESCRIPTION OF THE DRAWINGS

Further features and advantages will become apparent from the following description of the invention, which description is given solely by way of example with reference to the attached drawings among which:

FIG. 1 is a side view of an aircraft,

FIG. 2 is a perspective view of an air intake illustrating one embodiment of the prior art,

FIG. 3 is a perspective view of an air intake illustrating one embodiment of the invention,

FIG. 4 is a view in longitudinal section of a front part of an aircraft nacelle illustrating one embodiment of the invention,

FIG. 5 is a perspective view of a static spray system illustrating one embodiment of the invention, the actual system proper, which is ringed, being set out to the side of the figure in an enlarged view,

FIGS. 6A and 6B are views in longitudinal section of part of an aircraft nacelle comprising a mobile spray system illustrating one embodiment of the invention, the spray system being in the retracted position in FIG. 6A and in the deployed position in FIG. 6B,

FIG. 7 is a perspective view of part of an air intake illustrating the hidden detail of a reservoir of cleaning liquid according to one embodiment of the invention.

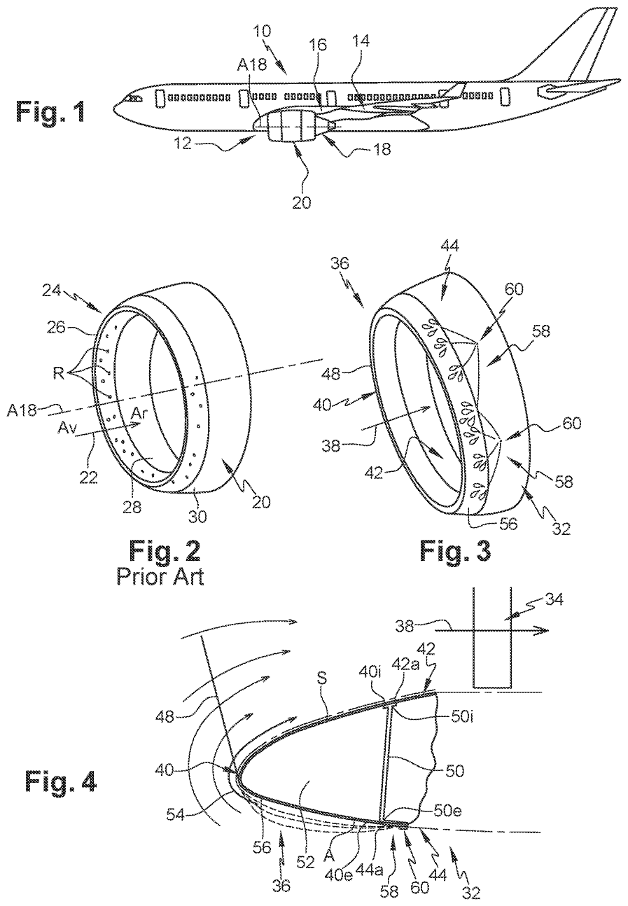

### DETAILED DESCRIPTION OF THE PREFERRED EMBODIMENTS

According to an embodiment visible in FIGS. 3 and 4, an aircraft propulsion assembly 12 (FIG. 1) comprises a power unit and a nacelle 32 positioned around the power unit. The latter comprises, at the front, a fan 34. The nacelle 32 has, in front of the fan 34, an air intake 36 channeling an interior airflow 38 towards the power unit and notably the fan 34. An air intake 36 comprises, at the front, a lip 40, an interior duct 42 extending the lip 40 toward the inside of the nacelle 32 in order to channel an airflow toward the power unit, and an exterior wall 44 extending the lip 40 on the outside of the nacelle 32. The nacelle 32 generally comprises cowls in the continuation of the exterior wall 44 of the nacelle 32.

In one embodiment, the air intake has a laminar aerodynamic profile (limiting aerodynamic disturbances) to achieve an improvement in terms of aerodynamic performance.

The lip 40 comprises a leading edge 48 which corresponds to the closed line situated farthest towards the front of the lip 40, which is approximately circular and extends over the entire circumference of the lip 40. When the fan 34 is not in operation, an airflow situated in front of the nacelle 32, traveling from front to rear, is split, at the leading edge 48, into an interior airflow 38 and an exterior airflow.

The lip 40, the interior duct 42 and the exterior wall 44 comprise an aerodynamic surface S (referenced in FIG. 4) in contact with airflows circulating through the interior duct 42 of the nacelle 32 and around the outside of the nacelle 32.

The nacelle 32 also comprises a front frame 50 in the form of an annulus which extends between an interior edge 50i (oriented toward the longitudinal axis of the power unit) and an exterior edge 50e. The lip 40 has an interior rear edge 40i situated approximately in the continuation of the front frame 50, in the vicinity of the interior edge 50i of the front frame 50, and an exterior rear edge 40e situated approximately in the continuation of the front frame 50, in the vicinity of the exterior edge 50e of the front frame 50. The lip 40 and the front frame 50 form an annular duct 52 which extends around the entire periphery of the air intake 36 and in a longitudinal plane has a D-shaped cross section.

The interior duct 42 has a front edge 42a adjoining the interior rear edge 40i of the lip 40 and may comprise one or more juxtaposed panels distributed over the circumference of the nacelle 32. The exterior wall 44 has a front edge 44a adjoining the exterior rear edge 40e of the lip 40 and may comprise one or more juxtaposed panels distributed around the circumference of the nacelle 32.

The nacelle 32 is not detailed further because it may be identical to that of the prior art.

As illustrated in FIG. 4, when the fan 34 is in operation, air is drawn into the nacelle 32. This induction phenomenon generates an incoming airflow 54 in contact with an exterior and forward region 56 of the aerodynamic surface S from a point A that is offset toward the rear and the outside of the nacelle in relation to the leading edge 48. Thus, the incoming airflow 54 passes around the lip 40 before entering the nacelle 32. The exterior and forward region 56 extends from the leading edge 48 towards the exterior wall 44 over a distance of at least 10 cm.

The exterior and forward region 56 has a dimension in the longitudinal direction that varies according to the induction phenomenon generated by the fan 34. It extends from the leading edge 48 of the lip 40 as far as a point A furthest from the leading edge 48 starting from which the induction phenomenon of the fan 34 produces an incoming airflow 54, in contact with the lip 40, which passes around the lip 40 before entering the nacelle 32.

When the power unit is generating maximum thrust, prior to takeoff for example, the exterior and forward region 56 extends as far as the exterior rear edge 40e of the lip 40. This exterior and forward region 56 extends around the entire circumference of the air intake 36.

The lip 40 and the interior duct 42 have a profile configured so that the incoming airflow 54 is laminar in contact with the aerodynamic surface S.

According to one embodiment, the propulsion assembly comprises a cleaning device 58 configured to spread at least a cleaning liquid over at least part of the exterior and forward region 56 of the aerodynamic surface S against which the laminar incoming airflow 54 flows.

The cleaning device 58 comprises several spray systems 60 distributed over at least part of the circumference of the nacelle 32, preferably uniformly, and configured to spray the cleaning liquid towards the exterior and forward region 56. The spray systems 60 are arranged in such a way that the cleaning liquid sprayed by the spray systems 60 combines at least in part with the incoming airflow 54 in order to be entrained thereby into contact with the exterior and forward region 56 over the entire circumference of the nacelle 32.

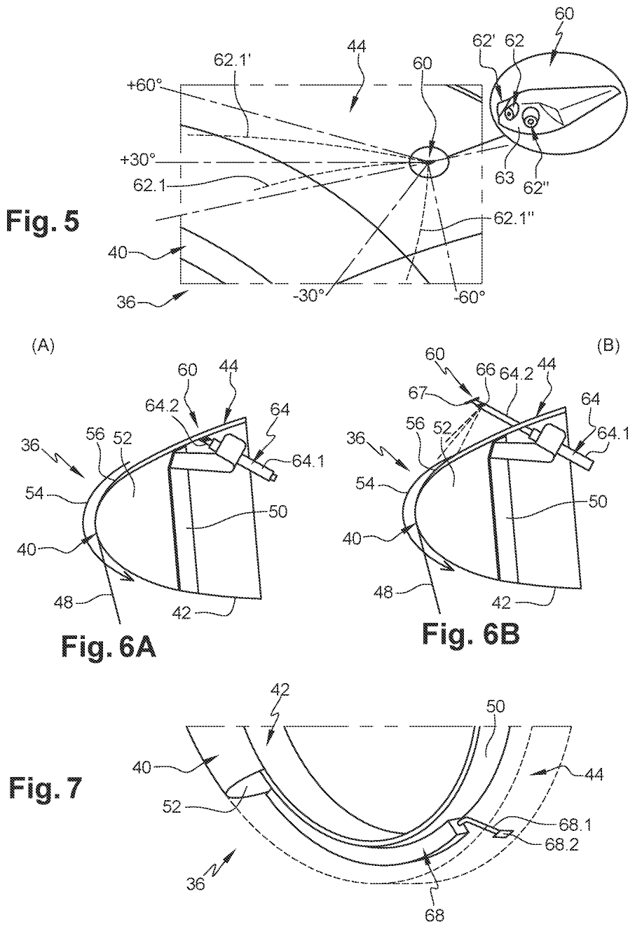

As illustrated in FIG. 5, each spray system 60 comprises at least one nozzle 62 configured to generate a jet of cleaning liquid 62.1. Each spray system 60 is positioned in a manner offset toward the rear with respect to the exterior rear edge 40e of the lip 40 and oriented in such a way as to spray the jet of cleaning liquid 62.1 toward the front, the jet of liquid preferably making an angle of less than approximately 70° with respect to the longitudinal direction. In addition, the jet of liquid sprayed by the spray system 60 forms with the aerodynamic surface S an angle of less than 30° so that the majority of the cleaning liquid sprayed is entrained by the incoming airflow 54 into contact with the exterior and forward region 56 over the entire circumference of the nacelle 32.

According to one embodiment, each spray system 60 comprises three nozzles 62, 62′, 62″, a first nozzle 62 spraying a jet of cleaning liquid 62.1 that is oriented toward the front and parallel to the longitudinal direction, a second nozzle 62′ spraying a jet of cleaning liquid 62.1′ that is oriented toward the front and makes an angle of between +30 and +60° with respect to the longitudinal direction, and a third nozzle 62″ that sprays a jet of cleaning liquid 62.1″ that is oriented toward the front and makes an angle of between −30° and −60° with respect to the longitudinal direction.

Naturally, the invention is not limited to this number of nozzles or to these orientations for the jets of cleaning liquid. In general, each spray system 60 comprises several nozzles 62 generating jets of cleaning liquid that are oriented in different directions.

According to one embodiment visible in FIG. 5, the spray system 60 is fixed and positioned on the aerodynamic surface S. In one configuration, each spray system 60 comprises a casing projecting from the aerodynamic surface S, with an aerodynamic profile (limiting the disturbances of the airflows) such as a teardrop shape for example, so as to limit the impact it has on the aerodynamic properties of the nacelle 32. According to one embodiment, the projecting casing has a profile that is symmetrical about a longitudinal plane and comprises a front part that has a reduced longitudinal dimension and a rear part that has a dimension in the direction perpendicular to the longitudinal direction that diminishes, at least in part, in the direction heading from front to rear and a dimension in the vertical direction that at least also, at least in part, diminishes in the direction from front to rear. The front part describes, at the aerodynamic surface, a semicircle and comprises an inclined face 63 that extends over a radius of the order of 180° and has an approximately frustoconical shape. The nozzles 62 are positioned on the inclined face 63 of the front part of the protruding casing.

According to an embodiment visible in FIGS. 6A and 6B, the spray system 60 is mobile able to move between a retracted position, visible in FIG. 6A, in which the spray system 60 does not project from the aerodynamic surface S, and a deployed position, visible in FIG. 6B, in which the spray system 60 projects from the aerodynamic surface S and can spray the cleaning liquid. According to one configuration, the spray system 60 comprises a telescopic strut 64 having a first part 64.1 secured to the nacelle 32, notably to the front frame 50, and a second part 64.2 that is mobile relative to the first part 64.1 and on which at least one nozzle 66 is positioned so that the nozzle 66 projects from the aerodynamic surface S when the spray system 60 is in the deployed position and does not project from the aerodynamic surface S when the spray system 60 is in the retracted position. The second part 64.2 has a free end 67 distant from the first part 64.1 and positioned at the aerodynamic surface S when the spray system 60 is in the retracted position, the free end 67 having a shape that lies flush with the aerodynamic surface S in order not to generate aerodynamic disturbances.

The spray systems 60 are positioned in such a way as to not disturb the airflow flowing against the aerodynamic surface S on the outside of the nacelle 32.

The jet of cleaning liquid is not necessarily sprayed at high pressure. According to the invention, the cleaning liquid is entrained at high speed by the incoming laminar airflow 54 in contact with the aerodynamic surface S. Thus, the combination of the cleaning liquid and of the laminar incoming airflow 54 makes it possible to obtain an abrasive or scrubbing effect in the manner of a high-pressure jet.

The cleaning device 58 comprises at least one reservoir 68 containing the cleaning liquid, a network of pipes connecting each spray system 60 to the reservoir 68 and at least one pump for conveying the cleaning liquid from the reservoir 68 to the spray systems 60. In one arrangement, the reservoir 68 is positioned in the nacelle 32, behind the front frame 50 and connected to the latter. In one embodiment, the reservoir 68 has an elongate and curved shape so that it can follow the radius of curvature of the interior duct 42 and at least one planar face so that it can be pressed up against the front frame 50.

In one configuration, the reservoir 68 has a capacity of the order of 10 to 15 liters. The reservoir comprises a filling pipe 68.1 opening via an opening that is sealed by a stopper and hidden behind a flap 68.2 lying flush with the aerodynamic surface S.

The cleaning liquid sprayed by the cleaning device 58 may be water. In one configuration, the cleaning liquid has rheological properties that allow it to form a persistent film on the aerodynamic surface S, configured to limit the attachment of insect residue. What is meant by persistent is that the film remains active and on the aerodynamic surface S for several minutes.

In operation, the risks of insect impact vary according to the weather conditions and the phases of flight. Thus, the risks of insect impact are the greatest when the air temperature is between 10 and 40° C. and the humidity is greater than or equal to 70%. They are also the greatest during takeoff and landing phases.

If necessary, the reservoir 68 is filled with cleaning liquid when the aircraft is stationary on the ground in its parking area. When the aircraft is moving from its parking area to the takeoff runway with the engines running at idle, the weather conditions may be conducive to insect impact.

In one possible mode of operation, the cleaning device of the invention can be activated by the pilot from the aircraft cockpit. It is activated for around the first ten seconds during which the power unit is generating maximum thrust prior to takeoff. This activation is initiated only when the weather conditions are conducive to insect impact.

The duration of activation varies from one aircraft to another. At minimum, the duration of activation is at least 2 seconds. In general, the duration of activation is between 5 and 15 seconds.

When the cleaning device is activated, the aircraft is static or traveling along the ground at low speed.

During this activation, the cleaning liquid is entrained by the high-speed incoming airflow 54 and acts like a high-pressure water jet encouraging the removal of insect residue.

By virtue of its rheological properties, the cleaning liquid forms a film on the aerodynamic surface S, limiting the attachment of insect residue for the rest of the takeoff phase.

The invention avoids insect residue remaining attached on the aerodynamic surfaces of the air intake and avoids the aerodynamic performance of the aircraft being adversely impacted.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft propulsion assembly comprising:
a power unit having a fan and an engine axis oriented in a longitudinal direction, and
a nacelle positioned around the power unit, said nacelle comprising:
a lip,
an interior duct extending the lip toward the inside of the nacelle, and
an exterior wall extending the lip on the outside of the nacelle,
the lip, the interior duct and the exterior wall exhibiting an aerodynamic surface,
the fan, during operation, generating an induction phenomenon and an incoming airflow in contact with an exterior and forward region of the aerodynamic surface;
wherein the propulsion assembly comprises a cleaning device configured to spread at least a cleaning liquid over at least part of the exterior and forward region of the aerodynamic surface against which the incoming airflow flows, the cleaning device comprising several spray systems distributed over at least part of a circumference of the nacelle and configured to spray the cleaning liquid toward the exterior and forward region.

2. The aircraft propulsion assembly as claimed in claim 1,
the nacelle comprising a front frame formed as an annulus which extends between an interior edge and an exterior edge, the lip having an interior rear edge situated approximately in a continuation of the front frame in a vicinity of the interior edge of the front frame, and an exterior rear edge situated approximately in the continuation of the front frame in a vicinity of the exterior edge of the front frame;
wherein each spray system comprises at least one nozzle configured to generate a jet of cleaning liquid, each spray system being positioned in a manner that is offset toward a rear region with respect to the exterior rear edge of the lip and oriented in such a way as to spray the jet of cleaning liquid toward the front.

3. The aircraft propulsion assembly as claimed in claim 2, wherein the jet of cleaning liquid forms an angle of less than 70° with respect to the longitudinal direction.

4. The aircraft propulsion assembly as claimed in claim 2, wherein each spray system comprises several nozzles generating jets of cleaning liquid oriented in different directions.

5. The aircraft propulsion assembly as claimed in claim 4, wherein each spray system comprises three nozzles, a first nozzle spraying a jet of cleaning liquid oriented toward the front and parallel to the longitudinal direction, a second nozzle spraying a jet of cleaning liquid oriented toward the front and forming an angle of between +30 and +60° with respect to the longitudinal direction, and a third nozzle spraying a jet of cleaning liquid oriented toward the front and forming an angle of between −30° and −60°.

6. The aircraft propulsion assembly as claimed in claim 1, wherein each spray system is fixed, positioned on the aerodynamic surface and comprises a casing projecting from the aerodynamic surface.

7. The aircraft propulsion assembly as claimed in claim 1, wherein each spray system is mobile being able to move between a retracted position in which the spray system does not project from the aerodynamic surface and a deployed position in which the spray system projects from the aerodynamic surface and is configured to spray the cleaning liquid.

8. The aircraft propulsion assembly as claimed in claim 7, wherein the spray system comprises a telescopic strut having a first part secured to the nacelle and a second part that is mobile relative to the first part and on which there is positioned at least one nozzle, such that said nozzle projects from the aerodynamic surface when the spray system is in the deployed position and does not project from the aerodynamic surface when the spray system is in the retracted position.

9. The aircraft propulsion assembly as claimed in claim 8, wherein the second part has a free end distant from the first part and positioned at the aerodynamic surface when the spray system is in the retracted position, said free end having a shape that lies flush with the aerodynamic surface.

10. The aircraft propulsion assembly as claimed in claim 9, wherein the cleaning device comprises at least one reservoir containing the cleaning liquid.

11. The aircraft propulsion assembly as claimed in claim 10, wherein the cleaning liquid has rheological properties that allow the cleaning liquid to form a persistent film on the aerodynamic surface.

12. A method of operating a cleaning device of an aircraft propulsion assembly as claimed in claim 1, comprising activating the cleaning device for at least two seconds during which the power unit generates maximum thrust prior to takeoff.

13. The method as claimed in claim 12, wherein the cleaning device is activated for an activation duration of between 5 and 15 seconds.
